(19) United States
(12) Patent Application Publication
(10) Pub. No.: US 2009/0000867 A1
(43) Pub. Date: Jan. 1, 2009

(54) Plastic ladder

(76) Inventor: Chen Lu Wang, Nantou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,348

(22) Filed: Jun. 27, 2007

(51) Int. Cl. E06C 1/02

(52) U.S. Cl. 182/104; 182/194

(57) ABSTRACT

A ladder made by plastic material includes a first ladder unit which includes two side rails with a plurality of rungs integrally connected between the two side rails. A head step is integrally connected to two respective top ends of the two side rails. The first ladder unit includes an open first side and a closed second side. Each of the rungs includes a latitude rib and altitude ribs connected to an inner periphery of the open first side so as to define a plurality of chambers in the open first side of each rung, and each side rail includes two sidewalls and a plurality of latitude ribs connected between the two sidewalls so as to define chambers separated by the latitude ribs. Each rung has an anti-slip top surface. A second ladder unit can be pivotably connected to the first ladder unit at two respective head steps.

### FIELD OF THE INVENTION

The present invention relates to a ladder and more particularly, to a plastic ladder made by way of sheet molding compound.

### BACKGROUND OF THE INVENTION

A conventional ladder 9 is shown in FIG. 13, and generally includes two units 92 which are connected at the respective head steps by hinges 91 and spreaders 93 are connected between two mediate portions of the units 92. Each unit 92 includes two side rails 94 and rungs 95 connected between the two side rails 94 by rivets 96. The conventional ladder 9 is made by Aluminum which is light and strong. However, the metal-made ladder 9 is conductive material which might hurt the user in some situations. Furthermore, each rung 95 is connected between the two side rails 94 by rivets 96 and it requires a lot of time.

The present invention intends to provide a ladder that is made by plastic material and can be made by way of sheet molding compound. Each rung is shaped to have a widen portion so as to increase the structural strength thereof.

### SUMMARY OF THE INVENTION

The present invention relates to a ladder made by plastic material and comprises a ladder unit including two side rails with a plurality of rungs integrally connected between the two side rails. A head step is integrally connected to two respective top ends of the two side rails. The ladder unit includes an open first side and a closed second side. Each of the rungs includes a latitude rib and altitude ribs connected to an inner periphery of the open first side so as to define a plurality of chambers in the open first side of each rung. Each side rail includes two sidewalls and a plurality of latitude ribs connected between the two sidewalls so as to define chambers separated by the latitude ribs. Each rung includes an anti-slip top surface.

The primary object of the present invention is to provide a plastic made ladder which is easily to manufactured and non-conductive, also has sufficient structural strength to meet requirements of tasks.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows steps of sheet molding compound for manufacturing the ladder of the present invention;

FIG. 2 shows the closed side of the first ladder unit of the present invention;

FIG. 3 shows the open side of the first ladder unit of the present invention;

FIG. 4 is a perspective view to show the first ladder unit of the present invention;

FIG. 5 is a cross sectional view taken along line A-A in FIG. 3;

FIG. 6 is a cross sectional view taken along line B-B in FIG. 3;

FIG. 7a shows a second embodiment of the ladder of the present invention wherein fastening members and a hinge are used to connect two respective head steps of first and second ladder units;

FIG. 7b shows that the two head steps are arranged to be closed to each other;

FIG. 7c shows that the two head steps are arranged to be separated from each other;

FIG. 8 shows a shoe is pivotably connected to each lower end of the side rail of the ladder;

FIG. 9 shows another embodiment of the shoe;

FIG. 10 shows another embodiment of the connection of the two respective head steps;

FIG. 11 shows yet another embodiment of the connection of the two respective head steps;

FIG. 12 shows a step board is fixed on each of the two head steps of the ladder, and

FIG. 13 shows a conventional ladder.

### DETAILED DESCRIPTION OF THE PREFERRED EMBODIMENT

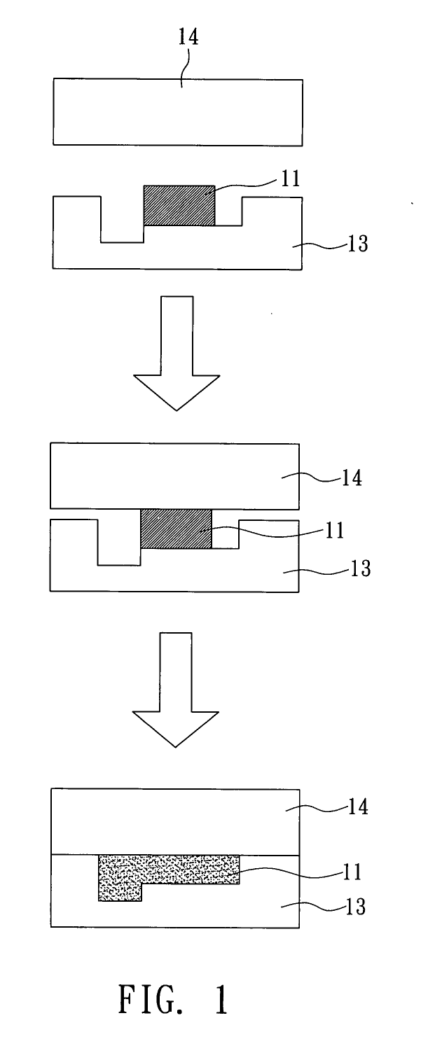

Referring to FIG. 1, a method of sheet molding compound is used to manufacture the plastic ladder of the present invention and the method comprises a mold unit which includes a first mold 13 and a second mold 14, between which a plastic material piece 11 is located. The first and second molds 13, 14 are heated and the plastic piece 11 is compressed, melted and spread into the concavities between the first and second molds 13, 14. When the first and second mold 13, 14 and the plastic piece 11 are cooled, the ladder is formed and can be removed from the mold unit. The method is one of available methods that can be used to manufacture the plastic ladder of the present invention.

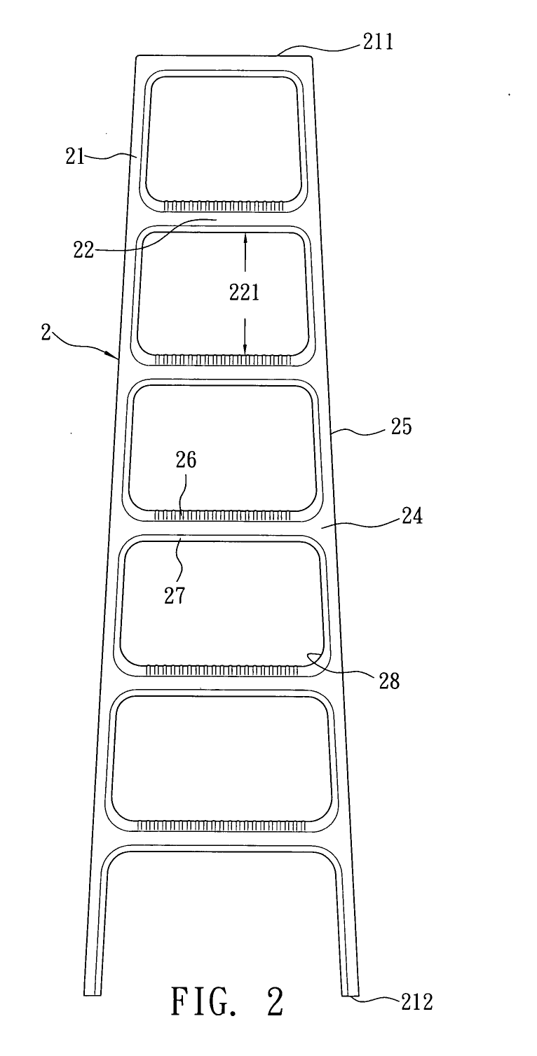

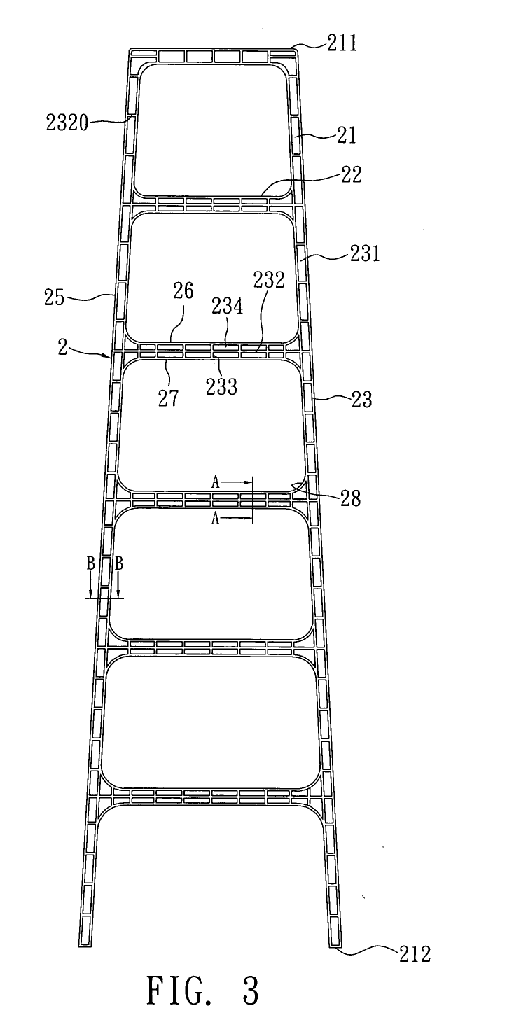

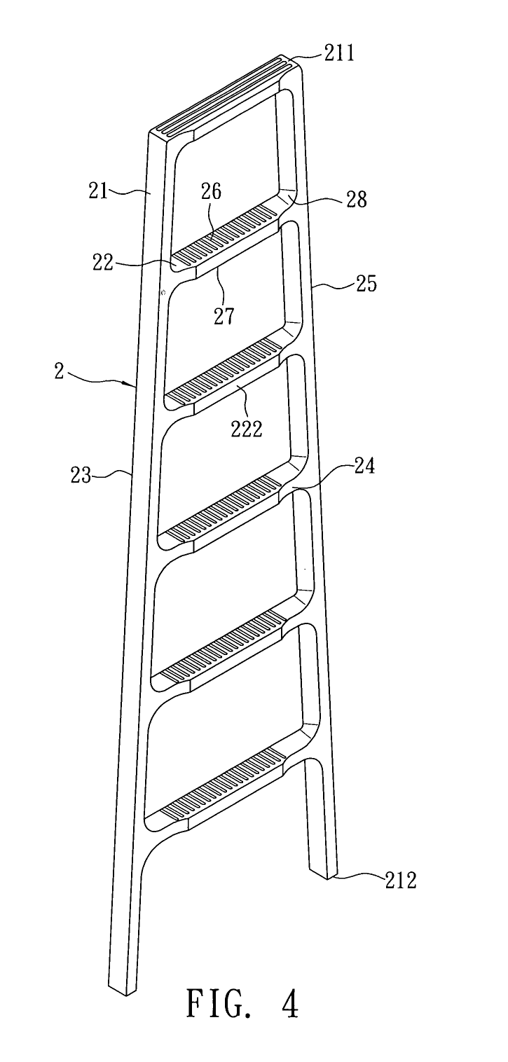

FIGS. 2 to 4 disclose the first ladder unit 2 of the ladder of the present invention, wherein the first ladder unit 2 includes two side rails 21 with a plurality of rungs 22 integrally connected between the two side rails 21. The distance between adjacent rungs 22 can be fixed as designated as the reference 221. A head step 211 is integrally connected to two respective top ends of the two side rails 21 and each side rail 21 has a lower end. Because of the above-mentioned molding method, the first ladder unit 2 includes an open first side 23 and a closed second side 24. Each of the rungs 22 includes a latitude rib 232 and altitude ribs 233 connected to an inner periphery of the open first side 23 so as to define a plurality of chambers 234 in the open first side 23 of each rung 22. The latitude rib 232 and altitude ribs 233 reinforce the structural strength of the rungs 22. Each side rail 21 includes two sidewalls 25 and a plurality of latitude ribs 2320 are connected between the two sidewalls 25 so as to define chambers 231 separated by the latitude ribs 2320. Each rung 22 includes an anti-slip top surface 26 and a widen portion 222 extends from the closed second side 24 of each rung 22 so as to increase the area on which the user can stand thereon. The anti-slip top surface 26 can be any known types such as ridges or bosses extending from the top surface of the rungs 22.

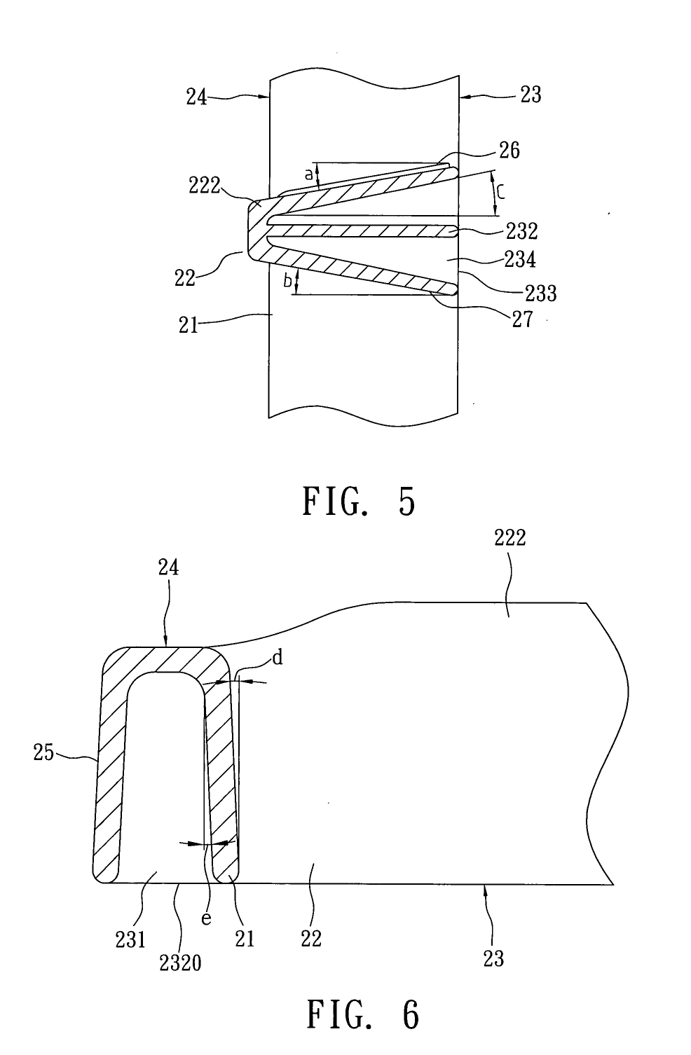

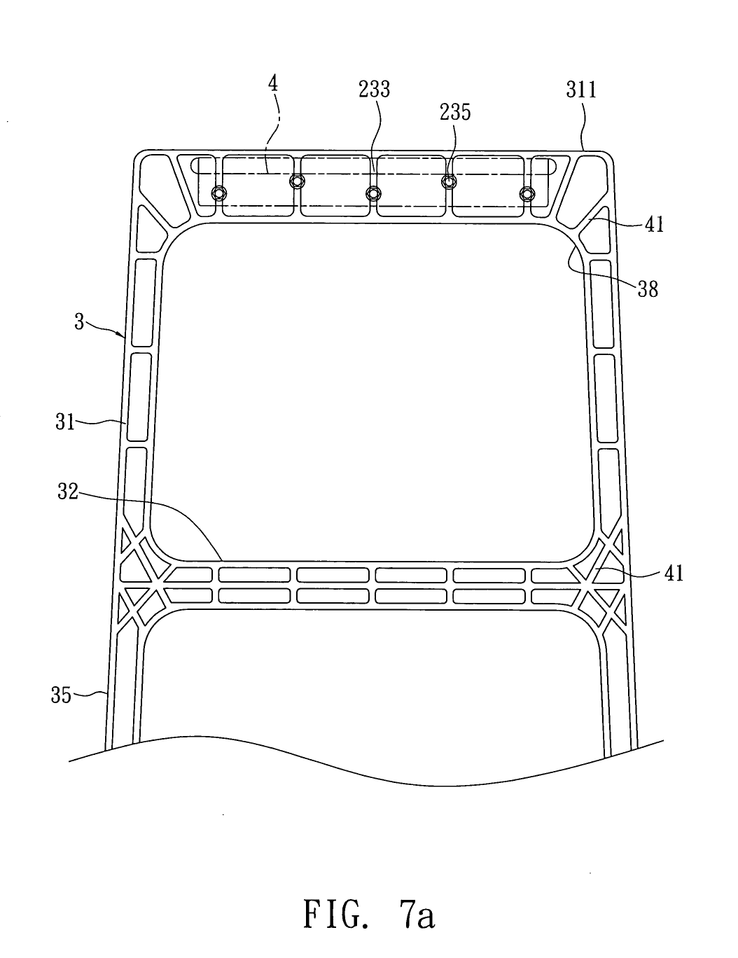

As shown in FIGS. 5 and 6, the anti-slip top surface 26 of each of the rungs 22 is inclined at an angle “a” which is defined between a horizontal plane and the anti-slip top surface 26. The bottom surface 27 of each rung 22 is inclined at an angle “b” which is defined between a horizontal plane and the bottom surface 27. The inner surface of each chamber 234 and is located at the opposite side surface of the anti-slip top surface 26 is also inclined at an angle “c” which is defined between a horizontal plane and the inner surface of each chamber 234.

Each of the side rails 21 includes a substantially U-shaped cross section and the two sidewalls 25 extend outward at an angle. Each sidewall 25 includes an inner surface and an outer surface, a first angle “d” is defined between the outer surface and a longitudinal plane perpendicular to the closed second side 24 of the first ladder unit 2. A second angle “e” is defined between the inner surface and the longitudinal plane perpendicular to the closed second side 24 of the first ladder unit 2.

As shown in FIG. 2 two curved reinforcement portions 28 are connected between each of two ends of each of the rungs 22 and the side rail 21 such that the concentration stress on these areas can be properly avoided.

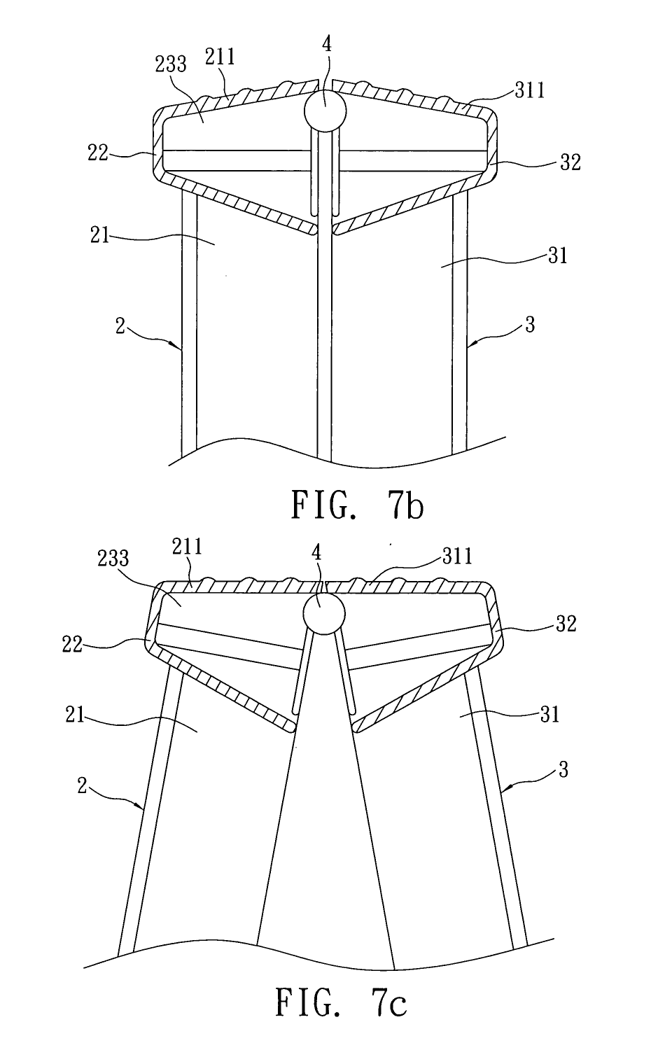

FIGS. 7a to 7c shows a second embodiment of the ladder of the present invention wherein fastening members 235 and a hinge 4 are used to connect two respective head steps 211, 311 of first and second ladder units 2, 3. The second ladder unit 3 is identical to the first ladder unit 2, two respective head steps 211, 311 of the first and second ladder units 2, 3 can be pivotable to each other so as to form a step ladder as shown in FIG. 7c when needed. Each of the two respective head steps 211, 311 includes a plurality of altitude ribs 233 and a fastening member 235 extends through each altitude rib 233 so as to connect the hinge 4 between the two respective head steps 211, 311 of the first and second ladder units 2, 3. As disclosed in FIG. 7a, each of the curved reinforcement portions 38 includes an inclined rib 41 located in the open first side 23 and the inclined rib 41 is connected between one of the sidewalls 35 of the rail 31 and the rung 32.

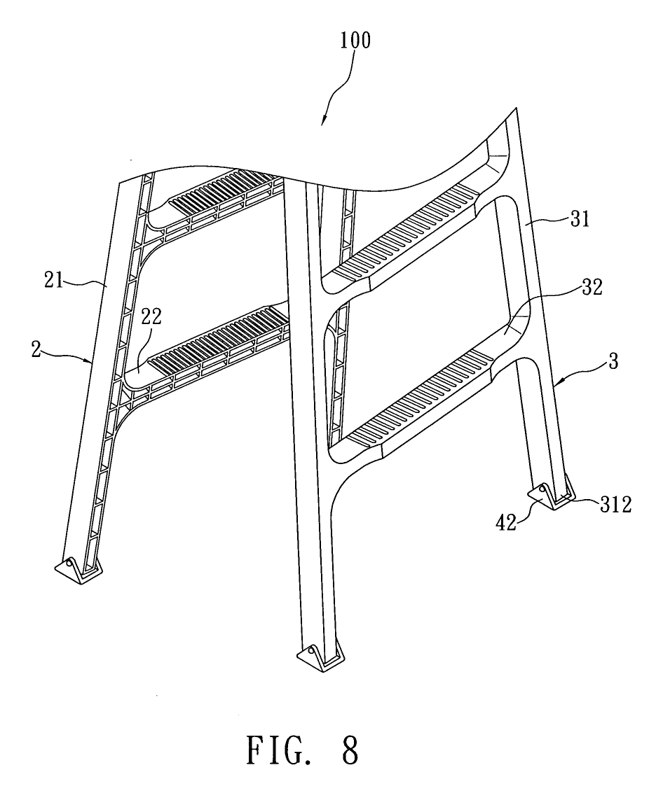

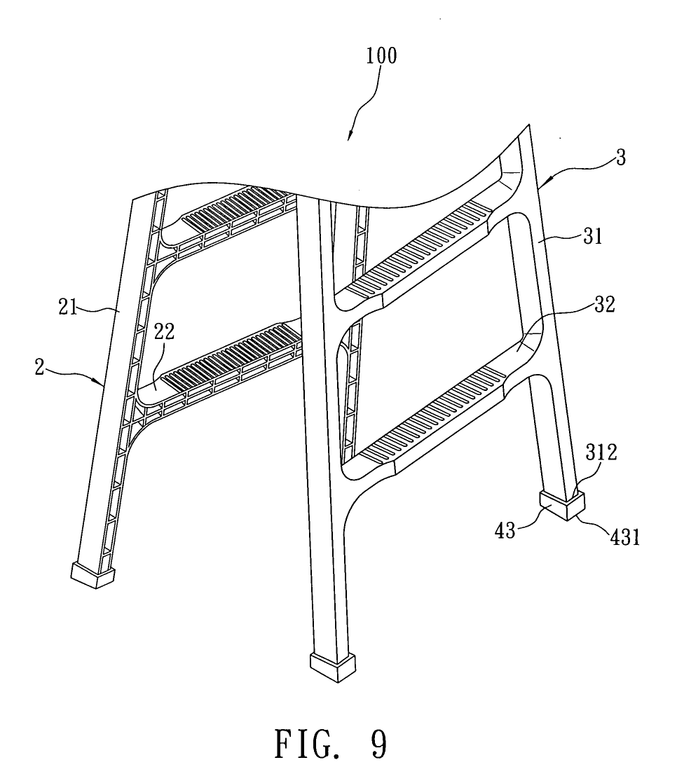

FIG. 8 shows that each of the two ladder units 2, 3 includes a shoe 42 pivotably connected to a lower end 312 of each side rail 21, 31. The pivotable shoes 42 ensure that the bottom surface of the shoes 42 are in contact with the floor or ground when using the ladder 100. FIG. 9 shows another embodiment of the shoe 43 wherein each of the two ladder units 2, 3 includes a shoe 43 mounted connected to a lower end 312 of each side rail 21, 31 and each shoe 42 includes an inclined bottom surface 431 which is in contact with the floor or the ground.

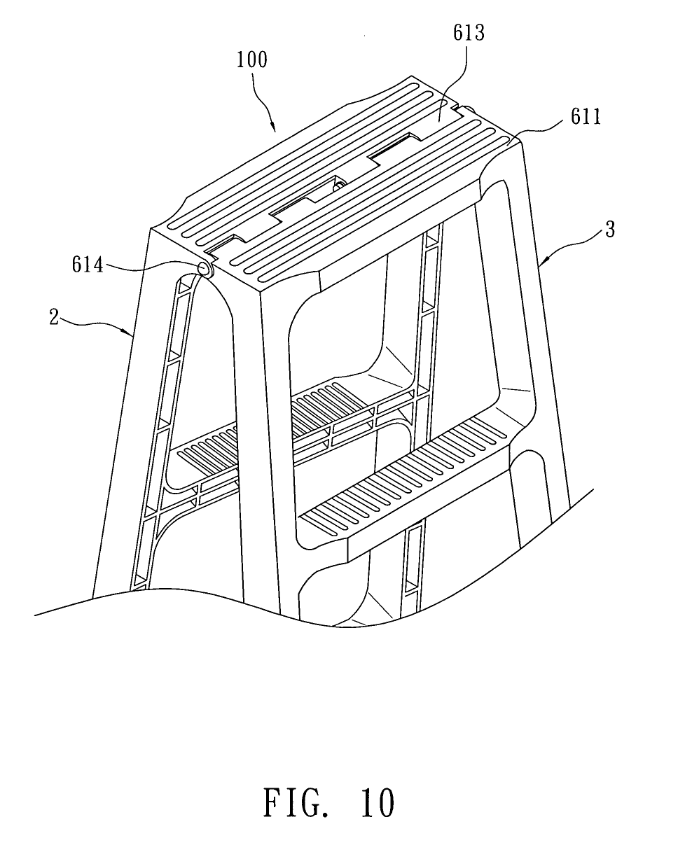

FIG. 10 shows that the head steps 611 of the two ladder units 2, 3 of the ladder 100 includes lugs 613 extending from an inner side thereof and the lugs 613 of the two head steps 611 of the first and second ladder units 2, 3 are located alternatively to each other. Two pins 614 extend through the lugs 613 to pivotably connect the two head steps 611.

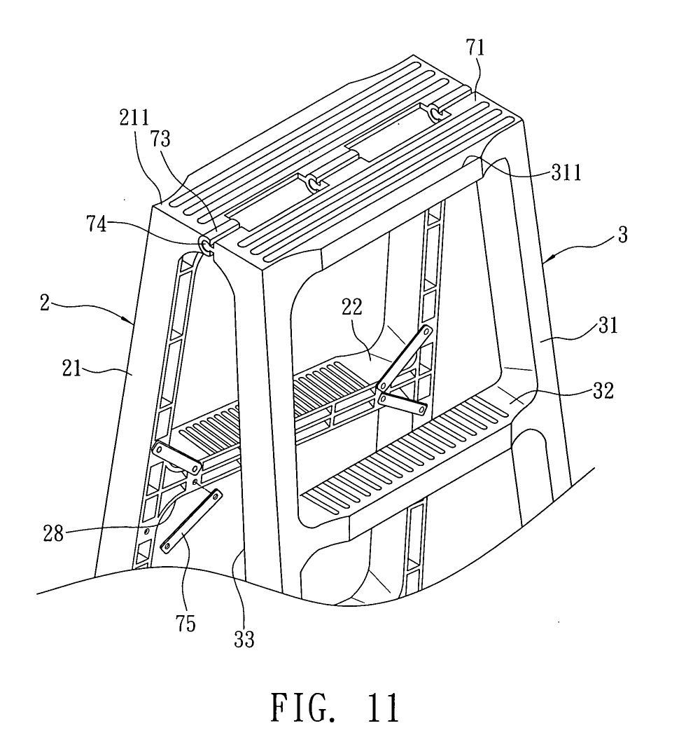

FIG. 11 shows that the head step 211 of the first ladder unit 2 includes a plurality of C-shaped members 73 extending from an inner side thereof and the head step 311 of the second ladder unit 3 includes a plurality of pivots 74 extending from an inner side thereof, the pivots 74 are pivotably received in the C-shaped members 73. Besides, two reinforcement plates 75 are connected between the two respective side rails 21 and two ends of each of the rungs 22.

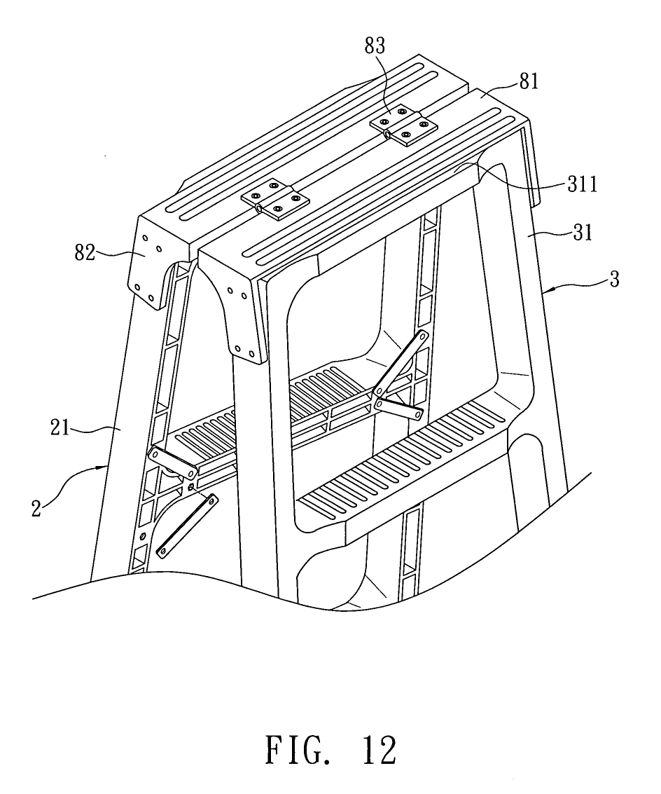

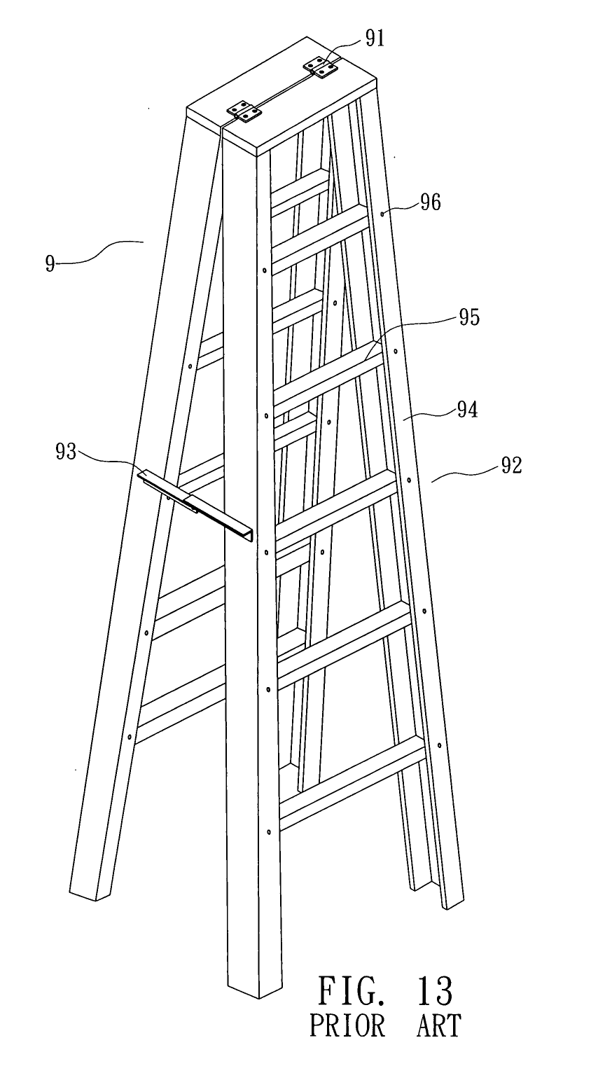

FIG. 12 shows that two step boards 81 are respectively mounted on the two head steps 211, 311 of the first and second ladder units 2, 3, the two step boards 81 are connected to each other by two hinges 83. Each of the two step boards 81 includes two end plates 82 which are fixed to the two respective sidewalls of the two side rails 21, 31. Each top surface of the step boards 81 may include patterns, bosses, raised portions or recesses to prevent the user from slipping.

While we have shown and described the embodiment in accordance with the present invention, it should be clear to those skilled in the art that further embodiments may be made without departing from the scope of the present invention.

What is claimed is:

1. A ladder made by plastic material, comprising:
a first ladder unit including two side rails with a plurality of rungs integrally connected between the two side rails, a head step integrally connected to two respective top ends of the two side rails and two lower ends of the two side rails adapted to contact ground, two shoes respectively mounted to the two lower ends of the two side rails, the first ladder unit including an open first side and a closed second side, each of the rungs including a latitude rib and altitude ribs connected to an inner periphery of the open first side so as to define a plurality of chambers in the open first side of each rung, an inclined rib located in the open first side and the inclined rib connected between one of the sidewalls of the rail and the rung, each side rail having two sidewalls and each rung having an anti-slip top surface, each of the sidewalls and each of the anti-slip top surfaces being inclined so that the open first side being wider than the closed second side, each of the anti-slip top surfaces including patterns, bosses, raised portions or recesses, each of the rungs including a widen portion extending from the closed second side.

2. The ladder as claimed in claim 1 further comprising a second ladder unit which is identical to the first ladder unit, two respective head steps of the first and second ladder units are pivotably connected to each other by a hinge, two spreaders are pivotably connected between the first and second ladder units.

3. The ladder as claimed in claim 1 further comprising a second ladder unit which is identical to the first ladder unit, two respective head steps of the first and second ladder units are pivotably connected to each other, two step boards are respectively mounted on the two head steps of the first and second ladder units, each of the two step boards includes two end plates which are fixed to the two respective sidewalls of the two side rails, lugs extending from an inner side of each step boards and the lugs are located alternatively to each other, two pins extend through the lugs to pivotably connect the two step boards, each top surface of the step boards includes patterns, bosses, raised portions or recesses.

4. The ladder as claimed in claim 1 further comprising a second ladder unit which is identical to the first ladder unit, two respective head steps of the first and second ladder units are pivotably connected to each other, lugs extend from an inner side of each the head steps and the lugs are located alternatively to each other, two pins extend through the lugs to pivotably connect the two head steps.
